(19) United States
(12) Patent Application Publication
(10) Pub. No.: US 2021/0004406 A1
(43) Pub. Date: Jan. 7, 2021

(54) METHOD AND APPARATUS FOR STORING MEDIA FILES AND FOR RETRIEVING MEDIA FILES

(71) Applicant: Baidu USA LLC, Sunnyvale, CA (US)

(72) Inventors: Xi Chen, Sunnyvale, CA (US); Yichen Hu, Sunnyvale, CA (US); Hao Tian, Sunnyvale, CA (US)

(21) Appl. No.: 16/460,265

(22) Filed: Jul. 2, 2019

(51) Int. Cl. G06F 16/783; G06F 16/75; G06F 16/71; G06F 16/738; G10L 13/04

(52) U.S. Cl. CPC G06F 16/7844; G06F 16/75; G10L 13/043; G06F 16/738; G06F 16/71

(57) ABSTRACT

Embodiments of the present disclosure disclose a method and apparatus for storing a media file and for searching a media file. A specific embodiment of the method includes: acquiring a semantic vector for characterizing semantics of a context of the media file, the context being a context of the media file in a webpage presenting the media file; and storing the semantic vector and the media file in association. Based on the corresponding relationship established by this embodiment, the semantic vector corresponding to the media file may be used to match the media file to ensure the semantic matching of the media file.

### CROSS-REFERENCE TO RELATED APPLICATIONS

### Technical Field

Embodiments of the present disclosure relate to the field of computer technology, specifically to a method and apparatus for storing a media file and for searching a media file.

### BACKGROUND

In some application scenarios, different types of media files need to be matched. For example, matching a corresponding video for a text, or matching a corresponding text for a video.

Typically, feature vectors extracted from a media file are used to characterize the media file and the media file is matched by matching the feature vectors. However, the feature vectors used are usually physical features extracted from the media file, generally an objectivity description of the media file without rich semantic information.

### SUMMARY

Embodiments of the present disclosure propose a method and apparatus for storing a media file.

In a first aspect, the embodiments of the present disclosure provide a method for storing a media file, including: acquiring a semantic vector for characterizing semantics of a context of the media file, the context being a context of the media file in a webpage presenting the media file; and storing the semantic vector and the media file in association.

In some embodiments, the acquiring a semantic vector for characterizing semantics of a context of the media file, includes: acquiring the semantic vector for characterizing the semantics of the context of the media file, in response to receiving a request for requesting to store the media file presented by the webpage.

In some embodiments, the semantic vector is obtained by: generating the semantic vector for characterizing the semantics of the context of the media file using a pre-trained semantic model, where the semantic model is used to generate a semantic vector for characterizing semantics of a text.

In some embodiments, the semantic model is obtained by training based on a knowledge-enhanced semantic representation model ERNIE.

In some embodiments, the method for storing a media file further includes: adding an index to the semantic vector based on an HNSW algorithm.

In some embodiments, the storing the semantic vector and the media file in association, includes: storing the semantic vector and the media file in association using MongoDB.

In a second aspect, embodiments of the present disclosure provide a method for searching a media file, including: acquiring a semantic vector for characterizing semantics of a text for search as a target semantic vector; and searching in a database to determine a predetermined number of media files, based on the target semantic vector, according to a similarity between a corresponding semantic vector and the target semantic vector in descending order, the database being pre-built by performing the following steps respectively for at least one media file: acquiring a semantic vector for characterizing semantics of a context of the media file, the context being a context of the media file in a webpage presenting the media file; and storing the semantic vector and the media file in association based on the database.

In some embodiments, the text for search is obtained by extraction from a text for presentation.

In some embodiments, the method for searching a media file further includes: generating a webpage presenting the text for presentation and the media file, where the text for presentation is the context of the media file in the webpage.

In some embodiments, the media file is a video; and the method for searching a media file further includes: generating a voice corresponding to the text for presentation based on a voice synthesis technology; adding the voice to the media file to generate a media file for presentation; and presenting the media file for presentation.

In a third aspect, the embodiments of the present disclosure provide an apparatus for storing a media file, including: a first acquisition unit, configured to acquire a semantic vector for characterizing semantics of a context of the media file, the context being a context of the media file in a webpage presenting the media file; and a storing unit, configured to store the semantic vector and the media file in association.

In some embodiments, the first acquisition unit is further configured to: acquire the semantic vector for characterizing the semantics of the context of the media file, in response to receiving a request for requesting to store the media file presented by the webpage.

In some embodiments, the semantic vector is obtained by: generating the semantic vector for characterizing the semantics of the context of the media file using a pre-trained semantic model, where the semantic model is used to generate a semantic vector for characterizing semantics of a text.

In some embodiments, the semantic model is obtained by training based on a knowledge-enhanced semantic representation model ERNIE.

In some embodiments, the apparatus for storing a media file further includes: an adding unit, configured to add an index to the semantic vector based on an HNSW algorithm.

In some embodiments, the storing unit is further configured to: store the semantic vector and the media file in association using MongoDB.

In a fourth aspect, the embodiments of the present disclosure provide an apparatus for searching a media file, including: a second acquisition unit, configured to acquire a semantic vector for characterizing semantics of a text for search as a target semantic vector; and a searching unit, configured to search in a database to determine a predetermined number of media files, based on the target semantic vector, according to a similarity between a corresponding semantic vector and the target semantic vector in descending order, the database being pre-built by performing the following steps respectively for at least one media file: acquiring a semantic vector for characterizing semantics of a context of the media file, the context being a context of the media file in a webpage presenting the media file; and storing the semantic vector and the media file in association based on the database.

In some embodiments, the text for search is obtained by extraction from a text for presentation.

In some embodiments, the apparatus for searching a media file further includes: a webpage generation unit, configured to generate a webpage presenting the text for presentation and the media file, where the text for presentation is the context of the media file in the webpage.

In some embodiments, the media file is a video; and the apparatus for searching a media file further includes: a voice generation unit, configured to generate a voice corresponding to the text for presentation based on a voice synthesis technology; a media file for presentation generation unit, configured to add the voice to the media file to generate a media file for presentation; and a presentation unit, configured to present the media file for presentation.

In a fifth aspect, the embodiments of the present disclosure provide an electronic device, including: one or more processors; a storage apparatus, for storing one or more programs; and the one or more programs, when executed by the one or more processors, cause the one or more processors to implement the method according to any one of the embodiments in the first aspect.

In a sixth aspect, the embodiments of the present disclosure provide a computer readable medium, storing a computer program thereon, the program, when executed by a processor, implements the method according to any one of the embodiments in the first aspect.

The method and apparatus for storing a media file provided by the embodiments of the present disclosure, by characterizing the media file by a semantic vector that may characterize semantics of a context of the media file in a webpage, and establishing a corresponding relationship between the semantic vector corresponding to the media file and the media file, the semantic vector corresponding to the media file may be used to match the media file to ensure the semantic matching of the media file, based on the established corresponding relationship.

### BRIEF DESCRIPTION OF THE DRAWINGS

After reading detailed descriptions of non-limiting embodiments with reference to the following accompanying drawings, other features, objectives and advantages of the present disclosure will become more apparent:

FIG. 1 is a diagram of an exemplary system architecture in which an embodiment of the present disclosure may be implemented;

FIG. 2 is a flowchart of an embodiment of a method for storing a media file according to the present disclosure;

FIG. 3 is a schematic diagram of an application scenario of the method for storing a media file according to an embodiment of the present disclosure;

FIG. 4 is a flowchart of another embodiment of the method for storing a media file according to the present disclosure;

FIG. 5 is a flowchart of an embodiment of a method for searching a media file according to the present disclosure;

FIG. 6 is a schematic structural diagram of an embodiment of an apparatus for storing a media file according to the present disclosure;

FIG. 7 is a schematic structural diagram of an embodiment of an apparatus for searching a media file according to the present disclosure; and

FIG. 8 is a schematic structural diagram of an electronic device adapted to implement the embodiments of the present disclosure.

### DETAILED DESCRIPTION OF EMBODIMENTS

The present disclosure will be further described below in detail in combination with the accompanying drawings and the embodiments. It may be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should be noted that the “a”, “a plurality of” modifications mentioned in the present disclosure are illustrative rather than restrictive. Those skilled in the art should understand that, unless clearly indicates otherwise in the context, it should be understood as “one or more.”

It should be noted that the embodiments in the present disclosure and the features in the embodiments may be combined with each other on a non-conflict basis. The present disclosure will be described below in detail with reference to the accompanying drawings and in combination with the embodiments.

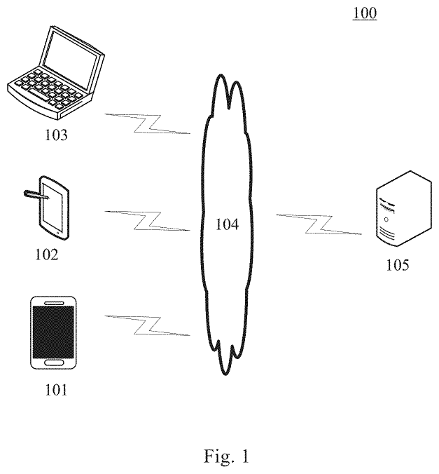

FIG. 1 illustrates an exemplary system architecture 100 of an embodiment of a method for storing a media file or an apparatus for storing a media file in which the present disclosure may be implemented.

As shown in FIG. 1, the system architecture 100 may include terminal devices 101, 102, 103, a network 104, and a server 105. The network 104 is used to provide a communication link medium between the terminal devices 101, 102, 103 and the server 105. The network 104 may include various types of connections, such as wired, wireless communication links, or optic fibers.

The terminal devices 101, 102, 103 interact with the server 105 through the network 104, to receive or send messages or the like. Various client applications may be installed on the terminal devices 101, 102, and 103. For example, browser applications, search applications, instant messaging tools, social platform software, etc.

The terminal devices 101, 102, 103 may be hardware or software. When the terminal devices 101, 102, and 103 are hardware, they may be various electronic devices, including but not limited to smart phones, tablet computers, E-book readers, laptop portable computers, desktop computers, or the like. When the terminal devices 101, 102, 103 are software, they may be installed in the above-listed electronic devices. They may be implemented as a plurality of software or software modules (for example, a plurality of software or software modules for providing distributed services), or as a single software or software module, which is not specifically limited herein.

The server 105 may be a server that provides various services, such as a backend server providing backend support for applications installed on the terminal devices 101, 102, 103. The server 105 may acquire a semantic vector for characterizing semantics of the context of the media file from the terminal devices 101, 102, 103, and store the semantic vector and a path to the corresponding media file in association.

It should be noted that the semantic vector for characterizing the semantics of the context of the media file may also be directly stored locally in the server 105. The server 105 may directly extract the semantic vector stored locally for characterizing the semantics of the context of the media file and process, in this case, the terminal devices 101, 102, 103 and the network 104 may not exist.

It should be noted that the method for storing a media file provided by the embodiments of the present disclosure is generally executed by the server 105. Accordingly, the apparatus for storing a media file is generally disposed in the server 105.

It should also be noted that the terminal devices 101, 102, 103 may also store the semantic vector and path to the corresponding media file in association. In this case, the method for storing a media file may also be executed by the terminal devices 101, 102, 103. Accordingly, the apparatus for storing a media file may also be disposed in the terminal devices 101, 102, 103. In this case, the exemplary system architecture 100 may not have the server 105 and the network 104.

It should be noted that the server 105 may be hardware or software. When the server 105 is hardware, it may be implemented as a distributed server cluster composed of a plurality of servers, or as a single server. When the server 105 is software, it may be implemented as a plurality of software or software modules (for example, for providing distributed services) or as a single software or software module, which is not specifically limited herein.

It should be understood that the number of terminal devices, networks and servers in FIG. 1 is merely illustrative. Depending on the implementation needs, there may be any number of terminal devices, networks and servers.

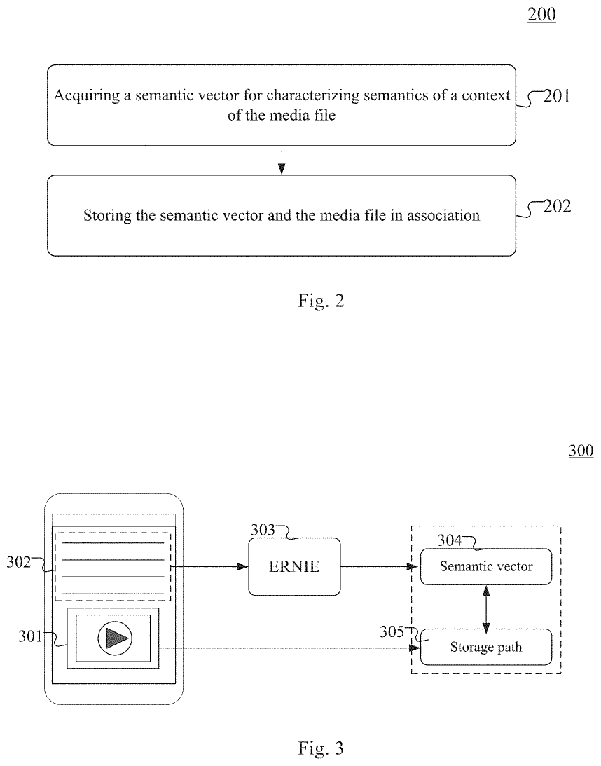

With further reference to FIG. 2, a flow 200 of an embodiment of a method for storing a media file according to the present disclosure is illustrated. The method for storing a media file includes the following steps:

Step 201, acquiring a semantic vector for characterizing semantics of a context of the media file.

In the present embodiment, an executing body of the method for storing a media file (for example, the server shown in FIG. 1) may acquire the semantic vector for characterizing the semantics of the context of the media file locally or from other storage devices.

The media file may include video, audio, images, and the like. The context of the media file may refer to the context of the media file in a webpage presenting the media file. Since the context of the media file in a webpage is usually strongly related to the media file, the semantic vector corresponding to the context of the media file may be used to describe semantic information of the media file.

The context of the media file may be obtained by analyzing the above webpage, or may also be extracted from the webpage by using a tool such as a web crawler. The semantic vector corresponding to the context of the media file may be obtained using various methods. For example, some open source tool (such as a trained model for extracting the semantic vector of a text) or a data platform may be used to obtain the semantic vector corresponding to the context of the media file.

In some alternative implementations of the present embodiment, the semantic vector corresponding to the context of the media file may be obtained by the following step: generating the semantic vector for characterizing the semantics of the context of the media file using a pre-trained semantic model. The semantic model may be used to generate a semantic vector for characterizing semantics of a text.

The semantic model may be obtained by training based on various types of untrained artificial neural networks (e.g., deep semantic matching models, long and short-term memory networks).

Alternatively, the semantic model may be obtained by training based on a knowledge-enhanced semantic representation model ERNIE. ERNIE (Enhanced Representation from Knowledge Integration) learns the semantic representation of the complete concept of the real world by learning the entity conceptual knowledge. Compared with some existing semantic models learning primitive language signals, ERNIE directly models prior semantic knowledge units, enhancing the ERNIE semantic representation ability, while modeling based on word feature input.

In addition, ERNIE is trained through introduced multi-source data corpus. For example, data such as encyclopedia, news information, and forum dialogues. Based on the extension of ERNIE to training corpus, especially the introduction of forum dialogue corpus, the semantic representation ability of ERNIE may be further enhanced.

Therefore, the strong semantic representation ability of ERNIE may be used to improve the accuracy of the semantic vector corresponding to the context of the media file, thereby improving the matching between the media file and the corresponding semantic vector.

Alternatively, the context of the media file may be pre-processed, and the semantic vector corresponding to the pre-processed context may be determined as the semantic vector of the context. For example, keyword/sentence extraction may be first performed on the context, etc.

It should be noted that the semantic vector for representing the semantics of the context of the media file may be obtained by processing the media file in advance by the executing body, or may be obtained by processing the media file by other electronic devices in advance.

Step 202, storing the semantic vector and the media file in association.

In the present embodiment, a corresponding relationship between the semantic vector corresponding to the context of the media file and the media file may be established. The specific establishing method may be flexibly set according to different application scenarios.

For example, the path to the media file may be acquired first, and then the semantic vector corresponding to the context of the media file and the path to the media file may be stored in association. The path to the media file may be used to indicate the storage location of the media file. Specifically, the path to the media file may be stored in advance on the executing body. In this case, the executing body may obtain the path to the media file locally. It may be understood that the path to the media file may also be input to the executing body by a user (such as those skilled in the art).

As another example, a corresponding relationship between the semantic vector corresponding to the context of the media file and identification information of the media file may be stored. In this case, the executing body may search to obtain the corresponding media file based on the identification information.

In some alternative implementations of the present embodiment, a media file set may be pre-specified by those skilled in the art. Then, for each media file in the media file set, the association storage between the semantic vector corresponding to the context of the media file and the media file may be implemented by the processing of the above steps 201-202, respectively. The media files in the media file set may be flexibly selected by those skilled in the art according to the actual application requirements.

In some alternative implementations of the present embodiment, in response to receiving a request for requesting to store the media file presented by the webpage, the semantic vector for characterizing the semantics of the context of the media file may be acquired.

The method for sending a request for requesting to store the media file presented by the webpage may be flexibly set according to a specific application scenario. For example, the access rate of the webpage presenting the media file may be examined, and when it is detected that the access rate is greater than a preset value, the request for requesting to store the media file presented by the webpage may be triggered. As another example, the request for requesting to store the media file presented by the webpage may be sent directly by those skilled in the art or the user based on a preset graphical user interface.

Thus, the corresponding relationship between the corresponding semantic vector of the context and the media file meeting the requirements may be established according to actual application requirements.

With further reference to FIG. 3, FIG. 3 is a schematic diagram 300 of an application scenario of the method for storing a media file according to the present embodiment. In the application scenario of FIG. 3, the executing body may acquire a context 302 of a video 301 in a webpage in advance. Then, a semantic vector 304 of the context 302 may be generated using a pre-trained model 303 based on ERNIE.

Then, the executing body may acquire a storage path 305 of the video 301, and establish a corresponding relationship between the storage path 305 and the obtained semantic vector 304.

The method provided by the above embodiment of the present disclosure characterizes the media file by a semantic vector that may characterize semantics of the context of the media file in a webpage, and establishes a corresponding relationship between the semantic vector corresponding to the media file and the media file. Thus, in many application scenarios involving recalling or sorting, etc. (applications such as content-based searches), the corresponding relationship established in this way may be used to accomplish a goal such as recalling or sorting based on more accurate semantic matching, thereby improving the accuracy of the recalling or sorting, etc.

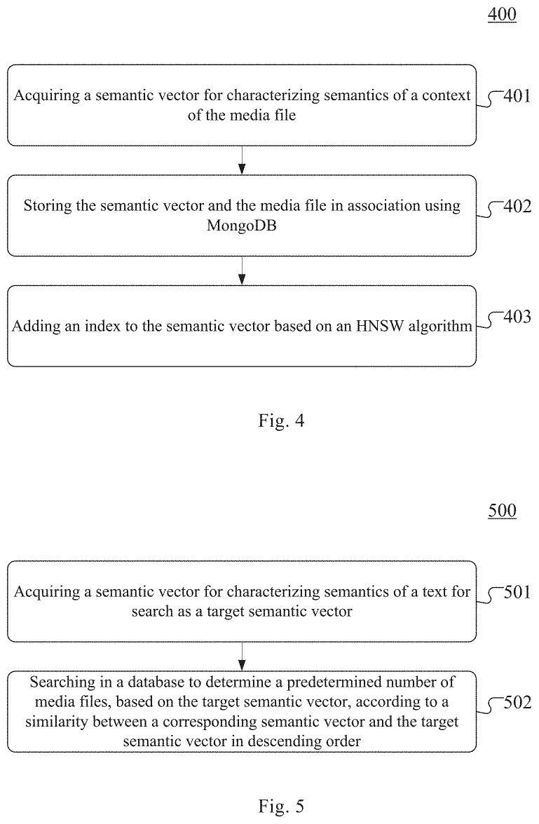

With further reference to FIG. 4, a flow 400 of another embodiment of the method for storing a media file is illustrated. The flow 400 of the method for storing a media file includes the following steps:

Step 401, acquiring a semantic vector for characterizing semantics of a context of the media file.

For the specific implementation process of the step 401, reference may be made to the related description of step 201 in the corresponding embodiment of FIG. 2, and detailed description thereof will be omitted.

Step 402, storing the semantic vector and the media file in association using MongoDB.

In the present embodiment, MongoDB is a database based on distributed file storage, and may provide scalable, high performance data storage. MongoDB may store complex data types and use efficient binary data storage to store large objects (such as videos). Based on the features of the MongoDB, the MongoDB may be easily used to directly store the media file and the corresponding semantic vector.

Step 403, adding an index to the semantic vector based on an HNSW algorithm.

In the present embodiment, HNSW (Hierarchical Navigable Small World graphs) is a graph-based algorithm. Currently, commonly used indexing methods include inversion-based methods, tree-based methods, hash-based methods, and the like. These indexing methods have less memory consumption, and the data dynamic additions and deletions are relatively flexible, but the recall rate and search speed are relatively poor in large-scale data search applications. However, HNSW has a high recall rate and a fast search speed in large-scale data search applications. Therefore, building an index based on the HNSW algorithm helps to improve the search speed and recall rate of media files afterwards.

The solution described in the present embodiment uses the MongoDB to store the semantic vector corresponding to the context of the media file and the media file in association, and adds an index to the semantic vector of the media file based on the HNSW algorithm, thereby implementing a convenient storage of the semantic vector corresponding to the context of the media file and the media file, and the HNSW algorithm is used to facilitate efficient search of the media file.

With further reference to FIG. 5, a flow 500 of an embodiment of a method for searching a media file according to the present disclosure is illustrated. The method for searching a media file includes the following steps:

Step 501, acquiring a semantic vector for characterizing semantics of a text for search as a target semantic vector.

In the present embodiment, the text for search may be obtained based on a text input by the user. For example, the text input by the user may be directly used as the text for search, or a text indicated by a search request sent by the user may be used as the text for search.

The semantic vector corresponding to the text for search may be obtained using some open source tool (such as a trained model for extracting the semantic vector of a text) or a data platform, or may be obtained using a pre-trained model for generating a semantic vector for characterizing semantics of a text, such as a model obtained by training based on ERNIE.

An executing body of the method for searching a media file (such as the server 105 shown in FIG. 1) may acquire the semantic vector corresponding to the text for search locally or from other device. It should be noted that the semantic vector corresponding to the text for search may be obtained by processing the text for search in advance by the executing body, or may be obtained by processing the text for search by other electronic devices in advance.

Step 502, searching in a database to determine a predetermined number of media files, based on the target semantic vector, according to a similarity between a corresponding semantic vector and the target semantic vector in descending order.

In the present embodiment, the database may be pre-built by performing the following steps respectively for at least one media file: acquiring a semantic vector for characterizing semantics of a context of the media file; and storing the semantic vector and the media file in association based on the database. The context of the media file may be a context of the media file in a webpage presenting the media file.

In the present embodiment, a corresponding relationship between the semantic vector and the media file may be established by using the database according to a specific application scenario. For example, the database may be used to store the corresponding relationship between the semantic vector corresponding to the context of the media file and the path to the media file. The path to the media file may be used to indicate the storage location of the media file. Thus, the corresponding media file may be obtained based on the path to the media file. As another example, a database such as MongoDB may also be used to directly store the media file and the corresponding semantic vector.

A preset number may be preset by those skilled in the art or may be determined according to a preset condition. The greater the similarity between the semantic vector corresponding to the media file and the target semantic vector, the higher the matching degree between the media file and the text for search that may be characterized.

In some alternative implementations of the present embodiment, the text for search may be obtained by extraction from a text for presentation. The text for presentation may refer to a text for presenting in a webpage. The method for extracting a text for search from a text for presentation may be flexibly selected. It may be understood that in some cases, the text for presentation may be directly used as the text for search.

In some alternative implementations of the present embodiment, after determining a predetermined number of media files, based on the target semantic vector, a webpage presenting the text for presentation and the media file may be further generated, and the text for presentation may be used as the context of the media file in the webpage. Thereby, some media files with higher relevance can be matched for the presentation text to be presented. Thus, some media files with higher relevance may be matched for the text for presentation to be presented.

In some alternative implementations of the present embodiment, the media file may be a video. In this case, a voice corresponding to the text for presentation may be generated based on a voice synthesis technology. Then, the generated voice may be added to the media file to generate a media file for presentation, and the obtained media file for presentation may be further presented. Thus, a video having high relevance may be matched for the text for presentation to be presented, and the voice corresponding to the text for presentation and the matched video may be combined to generate a video for presentation.

For example, in some scenarios that require voice broadcast, if it is desired to match the text to be broadcast with a video having a high content matching, the text to be broadcast may be determined as the text for presentation, and the above method may be used to obtain a video matching the text to be broadcast.

The method provided by the above embodiment of the present disclosure, based on the corresponding relationship between the semantic vector corresponding to the context of the media file and the media file established by the method described in the corresponding embodiment of FIG. 2, using the semantic vector corresponding to the text for search, and searching to obtain the media file having high matching degree with the text for search. Thus, the media file obtained by searching may be used as a matching media file for the text for presentation corresponding to the text for search, and the text for presentation and the corresponding matching media file may be presented in association to implement efficient search of the media file and ensure the content matching between the media file obtained by searching and the text for presentation.

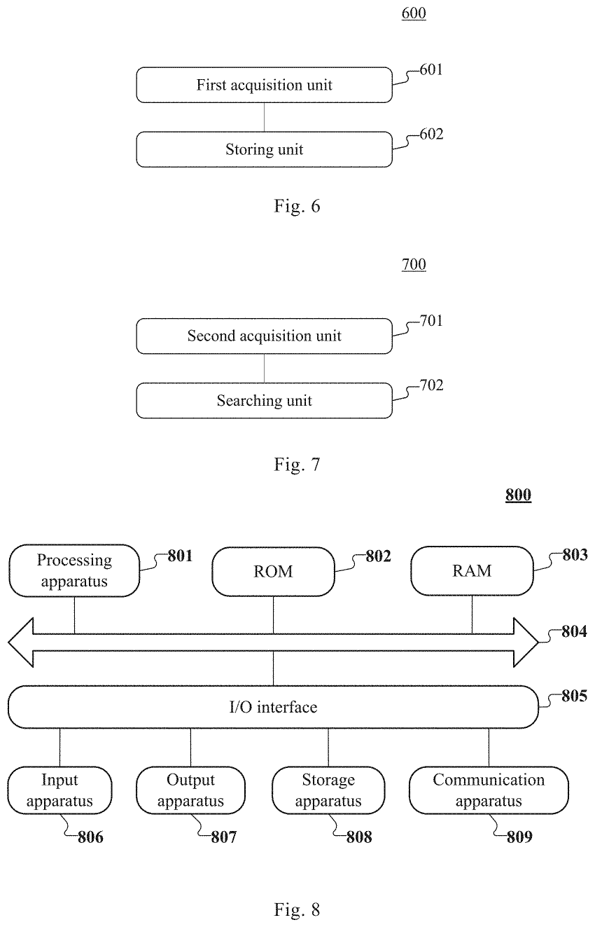

With further reference to FIG. 6, as an implementation of the method shown in the above figures, the present disclosure provides an embodiment of an apparatus for storing a media file, and the apparatus embodiment corresponds to the method embodiment as shown in FIG. 2, and the apparatus may be specifically applied to various electronic devices.

As shown in FIG. 6, an apparatus 600 for storing a media file provided by the present embodiment includes a first acquisition unit 601 and a storing unit 602. The first acquisition unit 601 is configured to acquire a semantic vector for characterizing semantics of a context of the media file, the context being a context of the media file in a webpage presenting the media file. The storing unit 602 is configured to store the semantic vector and the media file in association.

In the present embodiment, in the apparatus 600 for storing a media file, the specific processing and the technical effects thereof of the first acquisition unit 601 and the storing unit 602 may refer to the related descriptions of step 201 and step 202 in the corresponding embodiment of FIG. 2 respectively, and detailed description thereof will be omitted.

In some alternative implementations of the present embodiment, the first acquisition unit 601 is further configured to: acquire the semantic vector for characterizing the semantics of the context of the media file, in response to receiving a request for requesting to store the media file presented by the webpage.

In some alternative implementations of the present embodiment, the semantic vector is obtained by: generating the semantic vector for characterizing the semantics of the context of the media file using a pre-trained semantic model, where the semantic model is used to generate a semantic vector for characterizing semantics of a text.

In some alternative implementations of the present embodiment, the semantic model is obtained by training based on a knowledge-enhanced semantic representation model ERNIE.

In some alternative implementations of the present embodiment, the apparatus 600 for storing a media file further includes: an adding unit (not shown in the figure), configured to add an index to the semantic vector based on an HNSW algorithm.

In some alternative implementations of the present embodiment, the storing unit 602 is further configured to: store the semantic vector and the media file in association using MongoDB.

The apparatus provided by the above embodiment of the present disclosure, the first acquisition unit acquires a semantic vector for characterizing semantics of a context of the media file, the context being a context of the media file in a webpage presenting the media file, and the storing unit stores the semantic vector and the media file in association. Thus, in many application scenarios involving recalling or sorting, etc. (applications such as content-based searches), the corresponding relationship established in this way may be used to accomplish a goal such as recalling or sorting based on more accurate semantic matching, thereby improving the accuracy of the recalling or sorting, etc.

With further reference to FIG. 7, as an implementation of the method shown in the above figures, the present disclosure provides an embodiment of an apparatus for searching a media file, and the apparatus embodiment corresponds to the method embodiment as shown in FIG. 5, and the apparatus may be specifically applied to various electronic devices.

As shown in FIG. 7, an apparatus 700 for searching a media file provided by the present embodiment includes a second acquisition unit 701 and a searching unit 702. The second acquisition unit 701 is configured to acquire a semantic vector for characterizing semantics of a text for search as a target semantic vector. The searching unit 702 is configured to search in a database to determine a predetermined number of media files, based on the target semantic vector, according to a similarity between a corresponding semantic vector and the target semantic vector in descending order, the database being pre-built by performing the following steps respectively for at least one media file: acquiring a semantic vector for characterizing semantics of a context of the media file, the context being a context of the media file in a webpage presenting the media file; and storing the semantic vector and the media file in association based on the database.

In the present embodiment, in the apparatus 700 for searching a media file, the specific processing and the technical effects thereof of the second acquisition unit 701 and the searching unit 702 may refer to the related descriptions of step 501 and step 502 in the corresponding embodiment of FIG. 5 respectively, and detailed description thereof will be omitted.

In some alternative implementations of the present embodiment, the text for search is obtained by extraction from a text for presentation.

In some alternative implementations of the present embodiment, the apparatus 700 for searching a media file further includes: a webpage generation unit (not shown in the figure), configured to generate a webpage presenting the text for presentation and the media file, where the text for presentation is the context of the media file in the webpage.

In some alternative implementations of the present embodiment, the media file is a video; and the apparatus 700 for searching a media file further includes: a voice generation unit (not shown in the figure), configured to generate a voice corresponding to the text for presentation based on a voice synthesis technology; a media file for presentation generation unit (not shown in the figure), configured to add the voice to the media file to generate a media file for presentation; and a presentation unit (not shown in the figure), configured to present the media file for presentation.

The apparatus provided by the above embodiment of the present disclosure, the second acquisition unit acquires a semantic vector for characterizing semantics of a text for search as a target semantic vector, and the searching unit searches in a database to determine a predetermined number of media files, based on the target semantic vector, according to a similarity between a corresponding semantic vector and the target semantic vector in descending order, the database being pre-built by performing the following steps respectively for at least one media file: acquiring a semantic vector for characterizing semantics of a context of the media file, the context being a context of the media file in a webpage presenting the media file; and storing the semantic vector and the media file in association based on the database. Therefore, efficient search of the media file may be implemented, and the content matching between the media file obtained by searching and the text for presentation is ensured.

With further reference to FIG. 8, a schematic structural diagram of an electronic device (such as the server in FIG. 1) 800 adapted to implement the embodiments of the present disclosure is shown. The server shown in FIG. 8 is merely an example, and should not impose any limitation on the function and scope of use of the embodiments of the present disclosure.

As shown in FIG. 8, the electronic device 800 may include a processing apparatus (e.g., a central processing unit, a graphics processor, etc.) 801, which may execute various appropriate actions and processes in accordance with a program stored in a read-only memory (ROM) 802 or a program loaded into a random access memory (RAM) 803 from a storage apparatus 808. The RAM 803 also stores various programs and data required by operations of the electronic device 800. The processing apparatus 801, the ROM 802 and the RAM 803 are connected to each other through a bus 804. An input/output (I/O) interface 805 is also connected to the bus 804.

Generally, the following apparatuses may be connected to the I/O interface 805: an input apparatus 806 including such as a touch screen, a touch pad, a keyboard, a mouse, a camera, a microphone, an accelerometer, a gyroscope; an output apparatus 807 including such as a liquid crystal display (LCD), a speaker, a vibrator; a storage apparatus 808 including such as a magnetic tape, a hard disk; and a communication apparatus 809. The communication apparatus 809 may allow the electronic device 800 to communicate with other devices to exchange data through a wire or wireless connection. Although FIG. 8 illustrates the electronic device 800 having various apparatuses, it should be understood that it is not required to implement or provide all of the illustrated apparatuses. Alternatively, more or fewer apparatuses may be implemented or provided. Each block shown in FIG. 8 may represent one apparatus or may represent multiple apparatuses as desired.

In particular, according to the embodiments of the present disclosure, the process described above with reference to the flow chart may be implemented in a computer software program. For example, an embodiment of the present disclosure includes a computer program product, which includes a computer program that is tangibly embedded in a computer-readable medium. The computer program includes program codes for performing the method as illustrated in the flow chart. In such an embodiment, the computer program may be downloaded and installed from a network via the communication apparatus 809, or installed from the storage apparatus 808 or installed from the ROM 802. The computer program, when executed by the processing apparatus 801, implements the above mentioned functionalities as defined by the method of the embodiments of the present disclosure.

It should be noted that the computer readable medium of the embodiments of the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In the embodiments of the present disclosure, the computer readable storage medium may be any physical medium containing or storing programs which may be used by a command execution system, apparatus or element or incorporated thereto. In the embodiments of the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wired, optical cable, RF medium etc., or any suitable combination of the above.

The computer readable medium may be included in the above electronic device; or a stand-alone computer readable medium not assembled into the electronic device. The computer readable medium stores one or more programs. The one or more programs, when executed by the electronic device, cause the electronic device to: acquire a semantic vector for characterizing semantics of a context of the media file, the context being a context of the media file in a webpage presenting the media file; and store the semantic vector and the media file in association.

A computer program code for performing operations of the embodiments of the present disclosure may be compiled using one or more programming languages or combinations thereof. The programming languages include object-oriented programming languages, such as Java, Smalltalk, C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, the functions denoted by the blocks may occur in a sequence different from the sequences shown in the accompanying drawings. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system performing specified functions or operations, or by a combination of a dedicated hardware and computer instructions.

The units involved in the embodiments of the present disclosure may be implemented by means of software or hardware. The described units may also be provided in a processor, for example, may be described as: a processor including a first acquisition unit and a storing unit. Here, the names of these units do not in some cases constitute limitations to such units themselves. For example, the storing unit may also be described as “a unit configured to store the semantic vector and the media file in association”.

The above description only provides an explanation of the preferred embodiments of the present disclosure and the technical principles used. It should be appreciated by those skilled in the art that the inventive scope of the embodiments of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the embodiments of the present disclosure are examples.

1. A method for storing a media file, the method comprising:
acquiring a semantic vector for characterizing semantics of a context of the media file, the context being a context of the media file in a webpage presenting the media file; and
storing the semantic vector and the media file in association.

2. The method according to claim 1, wherein the acquiring a semantic vector for characterizing semantics of a context of the media file, comprises:
acquiring the semantic vector for characterizing the semantics of the context of the media file, in response to receiving a request for requesting to store the media file presented by the webpage.

3. The method according to claim 1, wherein the semantic vector is obtained by:
generating the semantic vector for characterizing the semantics of the context of the media file using a pre-trained semantic model, wherein the semantic model is used to generate a semantic vector for characterizing semantics of a text.

4. The method according to claim 3, wherein the semantic model is obtained by training based on a knowledge-enhanced semantic representation model ERNIE.

5. The method according to claim 1, wherein the method further comprises:
adding an index to the semantic vector based on an HNSW algorithm.

6. The method according to claim 1, wherein the storing the semantic vector and the media file in association, comprises:
storing the semantic vector and the media file in association using MongoDB.

7. A method for searching a media file, the method comprising:
acquiring a semantic vector for characterizing semantics of a text for search as a target semantic vector; and
searching in a database to determine a predetermined number of media files, based on the target semantic vector, according to a similarity between a corresponding semantic vector and the target semantic vector in descending order, the database being pre-built by performing following steps respectively for at least one media file:
acquiring a semantic vector for characterizing semantics of a context of the media file, the context being a context of the media file in a webpage presenting the media file; and storing the semantic vector and the media file in association based on the database.

8. The method according to claim 7, wherein the text for search is obtained by extraction from a text for presentation.

9. The method according to claim 8, wherein the method further comprises:
generating a webpage presenting the text for presentation and the media file, wherein the text for presentation is the context of the media file in the webpage.

10. The method according to claim 8, wherein the media file is a video; and
the method further comprises:
generating a voice corresponding to the text for presentation based on a voice synthesis technology;
adding the voice to the media file to generate a media file for presentation; and
presenting the media file for presentation.

11-20. (canceled)

21. An electronic device, comprising:
one or more processors; and
a storage apparatus, storing one or more programs thereon,
the one or more programs, when executed by the one or more processors, cause the one or more processors to:
acquiring a semantic vector for characterizing semantics of a context of the media file, the context being a context of the media file in a webpage presenting the media file; and
storing the semantic vector and the media file in association.

22. An electronic device, comprising:
one or more processors; and
a storage apparatus, storing one or more programs thereon,
the one or more programs, when executed by the one or more processors, cause the one or more processors to:
acquiring a semantic vector for characterizing semantics of a text for search as a target semantic vector; and
searching in a database to determine a predetermined number of media files, based on the target semantic vector, according to a similarity between a corresponding semantic vector and the target semantic vector in descending order, the database being pre-built by performing following steps respectively for at least one media file:
acquiring a semantic vector for characterizing semantics of a context of the media file, the context being a context of the media file in a webpage presenting the media file; and storing the semantic vector and the media file in association based on the database.

23. A computer readable medium, storing a computer program thereon, the program, when executed by a processor:
acquiring a semantic vector for characterizing semantics of a context of the media file, the context being a context of the media file in a webpage presenting the media file; and
storing the semantic vector and the media file in association.

24. A computer readable medium, storing a computer program thereon, the program, when executed by a processor:
acquiring a semantic vector for characterizing semantics of a text for search as a target semantic vector; and
searching in a database to determine a predetermined number of media files, based on the target semantic vector, according to a similarity between a corresponding semantic vector and the target semantic vector in descending order, the database being pre-built by performing following steps respectively for at least one media file:
acquiring a semantic vector for characterizing semantics of a context of the media file, the context being a context of the media file in a webpage presenting the media file; and storing the semantic vector and the media file in association based on the database.
